(19) United States
(12) Patent Application Publication
(10) Pub. No.: US 2009/0065124 A1
(43) Pub. Date: Mar. 12, 2009

(54) METHOD FOR THE ANTICORROSION COATING AND THE THERMALLY INSULATING COATING OF TUBULAR BODIES AND CONDUITS FOR THE TRANSPORT OF FLUID AND APPARATUS FOR IMPLEMENTING SUCH METHOD

(76) Inventor: Fernando Culzoni, Correggio (IT)

Correspondence Address: STITES & HARBISON PLLC, 1199 NORTH FAIRFAX STREET, SUITE 900, ALEXANDRIA, VA, 22314, US

(21) Appl. No.: 12/281,662

(22) PCT Filed: Mar. 1, 2007
(86) PCT No.: PCT/EP07/51964

§ 371 Date: Sep. 8, 2008

(30) Foreign Application Priority Data
Mar. 8, 2006 (IT) GE2006A000031

(51) Int. Cl. B32B 37/02; B05D 3/12

(52) U.S. Cl. 156/153; 427/299; 156/500

(57) ABSTRACT

Method for the anticorrosion and thermally insulating coating of tubular bodies and conduits for the transport of fluids, comprising the following stages in sequence. a) positioning on a tubular body (1, 17, 17′, 17″) requiring coating a series of devices (2, 4, 5, 5′, 5″) for automatic coating of such tubular body (1, 17, 17′, 17″) provided with suitable means (6, 7, 8, 9, 10, 11) for movement along such tubular body (1, 17, 17′, 17″) and/or moving supporting equipment (18, 21) capable of permitting such tubular body (1, 17, 17′, 17″) to move and if appropriate rotate in such automated coating devices (2, 4, 5), b) sandblasting of the surface of such tubular body (1, 17, 17′, 17″) using a suitable granular metal material, c) heating the surface of such tubular body (1, 17, 17′, 17″), d) applying an epoxy resin and an adhesive resin to such tubular body (1, 17, 17′, 17″), e) final coating of the tubular body (1, 17, 17′, 17″) with thermoplastic, thermohardening or the like coating material.

This invention relates to a method for the anticorrosion and thermally insulating coating of tubular bodies and conduits for the transport of fluids in workshops, in the field or on lay barges, and equipment for implementing such method.

In the construction of conduits for the transport of fluids, such as for example gas pipelines, oil pipelines, water pipelines, etc., metal pipe having external anticorrosion and thermally insulating coatings and tubular bodies, referred to as “fittings”, of various shapes and dimensions, such as for example elbows, “T” connections, reducers, etc., which have the function of connecting such metal pipes together, are used. When coating is applied in the workshop the ends of these fittings are left exposed, that is without coating, over a certain distance so that they can be subsequently welded to straight lengths of pipe or other connecting members either in the workshop or in the field, thus making the connecting joints.

At the present time the connecting joints between pipes and fittings are coated in workshops, in the field or on lay barges generally using cold sealed plastics tapes, thermoplastic resins, thermohardening resins and heat-shrinking sleeves. When these types of coatings are used, the physical and mechanical properties of the coating on the fittings and the joints are inferior to those of the coating on the straight pipes. This occurs in particular in the case of pipes coated with syntactic PE/PP or PE/PP polyethylene/polypropylene foam using the known three-layer or multilayer method, as at the present time there is no suitable procedure. In addition to this, at the present time the coating of fittings is essentially based on operations of the manual and conventional type, i.e.: sandblasting the metal surface of the fitting through positioning the tubular body on a suitable carriage or hook which moves on rails and placing it in a sandblasting booth where it is sandblasted manually using an air nozzle with metal shot by an operator or sandblasted by mechanical shot turbines located on the walls of the booth; the fitting is heated, removed from the sandblasting booth and placed on a suitable carriage or hook, inserting it into an air-blown furnace to heat it to a suitable temperature for the subsequent coating process, for example up to approximately 250° C. if the three-layer method is used. The fitting is coated, removed from the air-blown furnace and placed on a suitable carriage or hook and the required coating is applied as a spray. If the three-layer method of coating using thermoplastic materials is used, the heated part removed from the furnace is coated through the manual application of a first layer of a powder or liquid epoxy primer followed in quick sequence by spraying adhesive PE or PP copolymer powder. The abovementioned method is appropriate for coating thicknesses up to approximately 500-1000 microns. For coatings of greater thickness, for example up to 3-4 mm, it is necessary to repeat the operation of heating the part and applying resin several times in order to obtain the correct temperature for fusion and adhesion of the new layer of powder applied. Often the adhesion between the layers of resin applied to the parent coating is critical in the case of joints, because of the difficulty of achieving the narrow temperature range which provides good adhesion between the layers. In the case of large thickness coatings (i.e. 10-100 mm) using compact PE/PP, or PE/PP, PP/PPS (syntactic) foam the procedure is as follows: the heated part is coated by the application through manual spraying of a first layer of epoxy primer followed in quick sequence by the sprayed application of adhesive copolymer powders, and a metal mould is then applied around the pipe in order to create a gap of certain size which has to be filled through the injection of molten PE/PP or PES/PPS. In the case of coated elbows this mould is made of segments according to the minimum permitted thickness at the ends of the segment and this gives rise to an enormous loss of time and some difficulty in coating elbows.

From what has been stated above it is obvious that known methods of coating have a number of disadvantages, above all associated with manual operations, and are therefore dependent upon the ability of an operator, and also have various critical factors such as: temperatures which are difficult to control and repeat, non-homogeneous adhesion of the various coatings, non-uniform coating thicknesses, unspecified times for performing the coating stages, results which are difficult to repeat with the same characteristics, and the technical impossibility of obtaining coatings on fittings having the same characteristics as PE/PP, PES/PPS and PE/PP foam multilayer coatings which are currently achieved on straight pipes.

The main object of this invention is therefore to overcome the disadvantages of the known methods mentioned above through a method for the anticorrosion and thermally insulating coating of fittings, joints and fluid transport conduits in workshops, in the field or on lay barges which guarantees effective and uniform strength in the coating.

This object is accomplished through this invention by means of a method for the anticorrosion and thermally insulating coating of fittings, joints and conduits for the transport of fluids, characterised by the following stages in sequence:
a) positioning a series of automated devices for coating such tubular body on a tubular body and providing suitable means for movement along such tubular body and/or automated moving support equipment which allows such tubular body to move within such automated coating devices,
b) sandblasting the surface of such tubular body using a suitable granular metal material,
c) heating the surface of such tubular body,
d) applying an epoxy resin and an adhesive resin to such tubular body,
e) final coating of the tubular body preferably by extrusion with thermoplastics material,
f) as an alternative to stage e), coating the heated tubular body with thermohardening resins.

Another object of this invention is equipment for implementing the method, characterised in that it comprises: a first device for sandblasting the tubular body requiring treatment provided with a plurality of turbines for the delivery of granular sandblasting material, a second device provided with first induction heating means and second means for delivery of the epoxy primer and adhesive copolymer to the said tubular body, and a third final coating device provided with suitable means for delivery and/or extrusion of the material which has to be applied to the tubular body, these first, second and third devices being connected to means capable of permitting them to move in sequence along the tubular body requiring treatment and/or the tubular body being provided with such moving supporting equipment to allow such tubular body to move within such first, second and third treatment devices.

A further object of this invention is to provide suitable operating means on the tubular body, having a lenticular geometry with dimensions in length of between 50 and 400 mm, preferably between 100 and 200 mm, through which it is also possible to operate on curved tubular bodies having a minimum radius of curvature equal to twice the diameter of the tubular body.

Other features and advantages of this invention will be more apparent from the following description, provided by way of example and without restriction with reference to the appended drawings, in which:

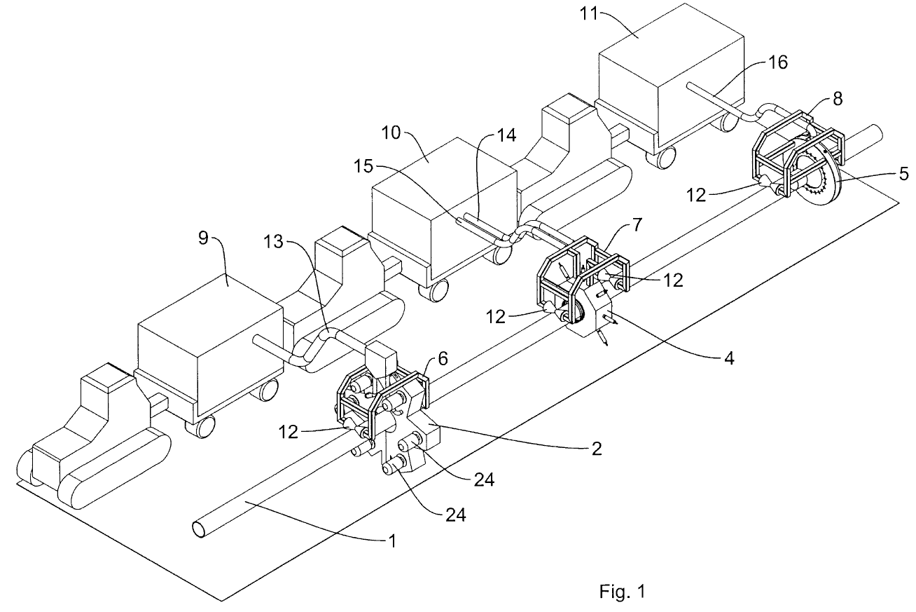

FIG. 1 illustrates a perspective view of a length of conduit for the transport of fluids on which lenticular annular devices are positioned in order to implement the method for anticorrosion and thermally insulating coating according to this invention,

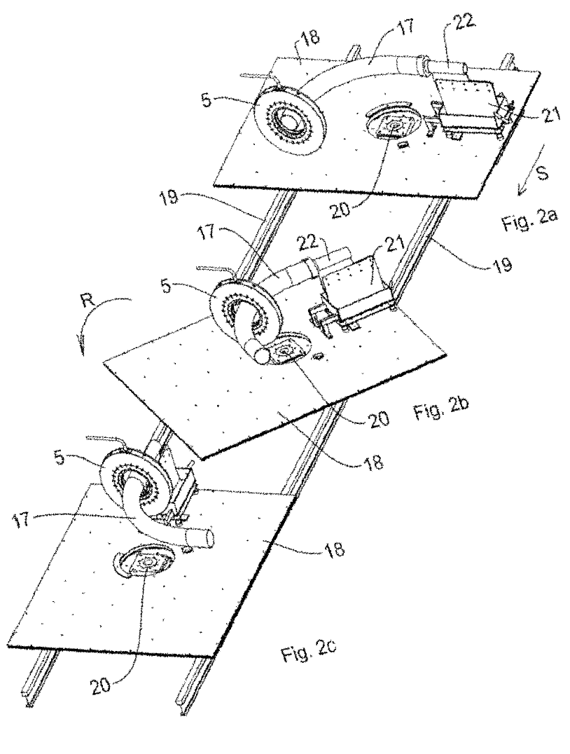

FIGS. 2a, 2b and 2c illustrate perspective views of a curved tubular body for the transport of fluids supported by moving equipment according to this invention, illustrated in three different positions at sequential stages during coating,

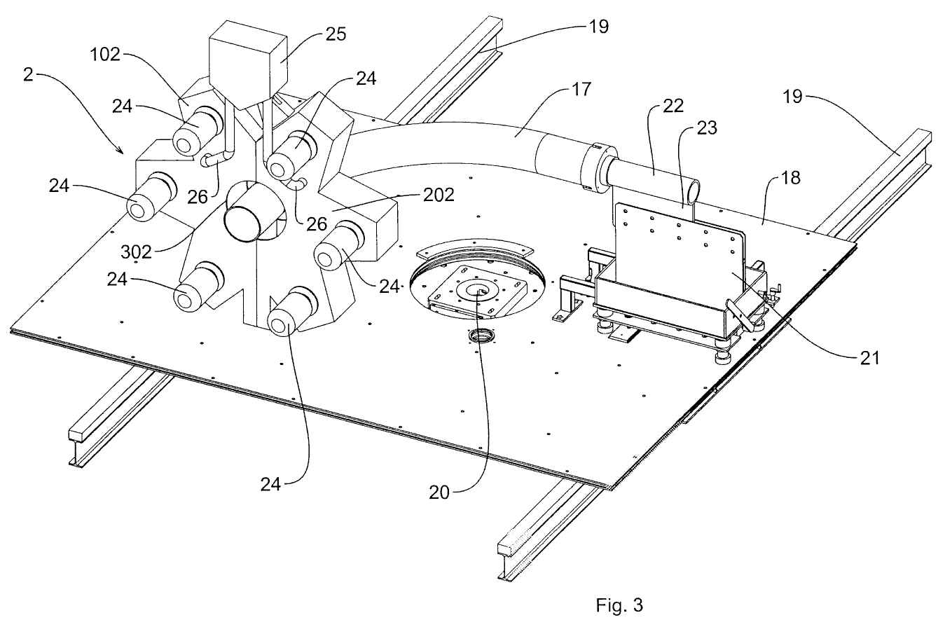

FIG. 3 illustrates a perspective view of a first embodiment of a lenticular annular sandblasting device according to this invention, positioned around the curved length of conduit for the transport of fluids,

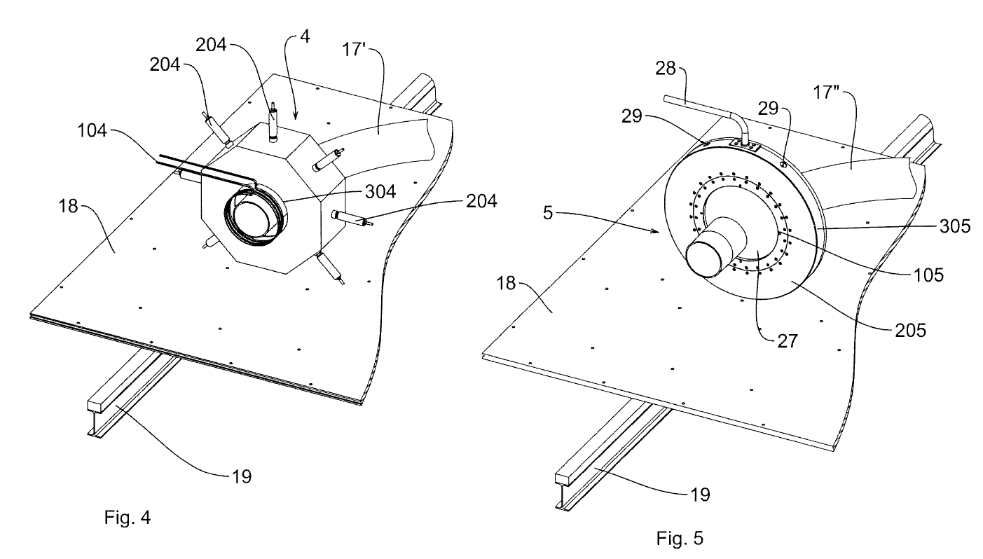

FIG. 4 illustrates a perspective view of a first embodiment of a device having a lenticular annular structure according to this invention for induction heating and delivering first epoxy and adhesive copolymer powder positioned around a curved section of conduit for the transport of fluids,

FIG. 5 illustrates a perspective view of a first embodiment of a final coating device according to this invention, with a lenticular extrusion cross-head positioned around a curved length of conduit for the transport of fluids,

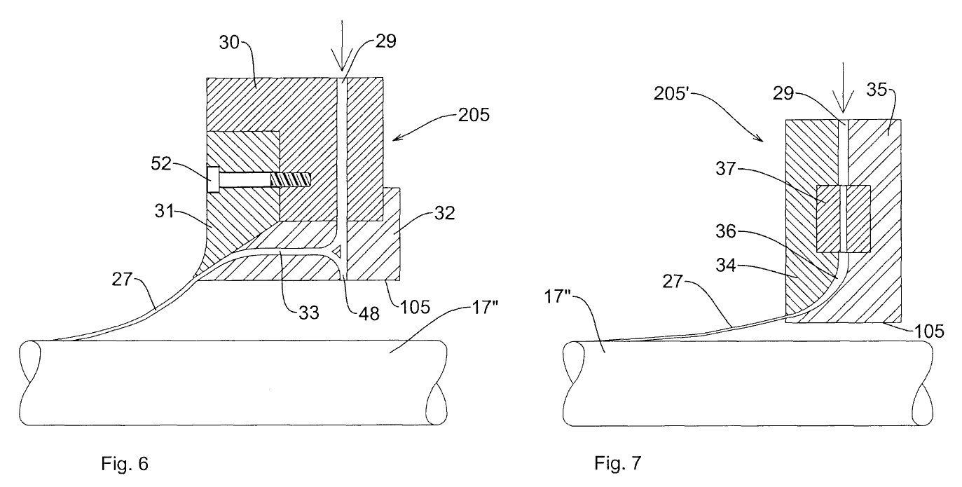

FIG. 6 illustrates a view in lateral elevation and cross-section of a first embodiment of the lenticular extrusion cross-head of the device in FIG. 5,

FIG. 7 illustrates a view in lateral elevation and cross-section of a second embodiment of the lenticular extrusion cross-head of the device in FIG. 5,

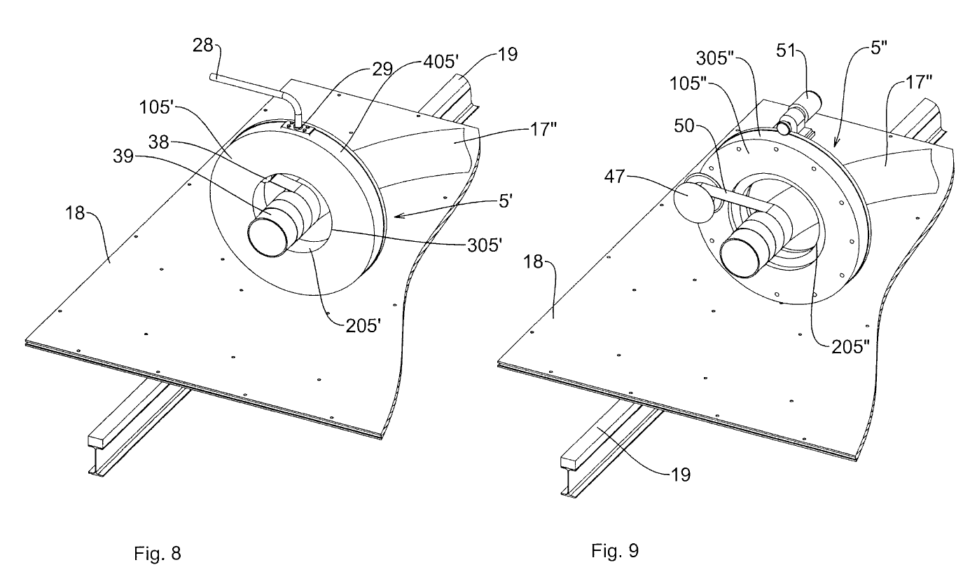

FIG. 8 illustrates a perspective view of a first embodiment of the final coating device provided with a rotating extrusion head positioned around a curved length of conduit for the transport of fluids,

FIG. 9 illustrates a perspective view of a first embodiment of the final coating device provided with a reel, having a lenticular annular structure and positioned around a curved length of conduit for the transport of fluids, and

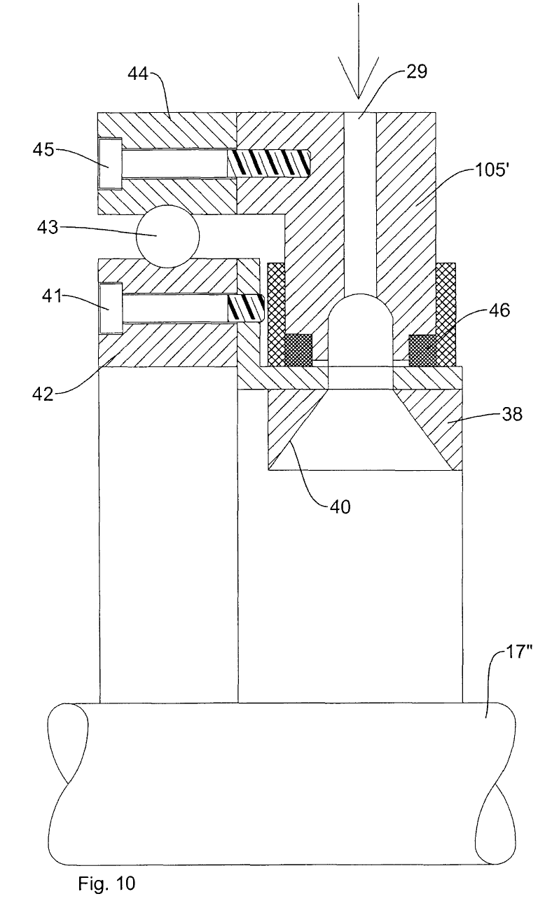

FIG. 10 illustrates a view in lateral elevation and cross-section of the flat rotating extrusion head in FIG. 8.

With reference to the appended drawings and with particular reference to FIG. 1 thereof, 1 indicates a length of conduit for the transport of fluids about which are located in sequence: a sandblasting device 2 having a preferably openable lenticular annular structure comprising a series of six turbines 24 for projecting metal shot and provided with a corresponding transfer structure 6 straddling the said straight length 1 of the conduit, a device 4 having a preferably openable lenticular annular structure for induction heating and delivering epoxy primer and adhesive copolymer, provided with a corresponding transfer structure 7, and a final coating device 5 having a preferably openable lenticular annular structure provided with a corresponding transfer structure 8. Three drive means 9, 10, 11 provided with corresponding motive power and capable of drawing and causing devices 2, 4 and 5 to move along said length 1 of the conduit through suitable guide rollers 12 with which transfer structures 6, 7 and 8 of those devices 2, 4 and 8 are provided are shown parallel to the length of conduit 1 requiring coating. The metal shot present in drive means 9 is delivered to sandblasting device 2 via a corresponding feed conduit 13. The epoxy primer and adhesive copolymer, which may be liquid or powder, are instead contained in drive means 10, from which they are delivered to device 4 for heating and applying a said epoxy primer and said copolymer through two feed conduits 14 and 15. The final coating material for length 1 of the conduit is instead contained in drive means 11 and is delivered to final coating device 5 via a corresponding feed conduit 16. The dimensions of the lenticular structure forming devices 2, 4 and 5 varies according to the longitudinal axis of the conduit which has to be coated, between approximately 50 and approximately 400 m, and preferably between 100-200 mm, in order that it can operate on tubular bodies or straight or curved lengths of pipe having a minimum radius of curvature equal to twice the diameter of the tubular body.

Thus in the case of conduits in the field or in the workshop having straight and curved lengths as illustrated in FIG. 1, devices 2, 4 and 5 are moved along the conduit requiring coating. In the case of fittings or curved sections, which generally comprise an intermediate curved length and two straight lengths welded to the ends, see for example curved length 17 in FIGS. 2a, 2b, 2c, a suitable moving device is used in order to proceed with the various stages of coating which will be described below. This device comprises a motor-driven table 18 positioned on two parallel rails 19 and provided centrally with a rotation pin 20. This motor-driven table 18 can therefore run along said tracks 19 and rotate about said rotation pin 20. Said motor-driven table 18 comprises a pair of supporting plates 21 on one side between which there is inserted a mandrel 22 supporting curved fitting 17 fixed to one extremity thereof. Preferably this pair of plates 21 is located on motor-driven table 18 in such a way that the distance between rotation pin 20 and said plates 21 is equal to the radius of curvature of curved fitting 17 requiring treatment. In the figures, final coating device 5 described in FIG. 1 is illustrated by way of example. The ends of such curved fitting 17 are positioned at the same height with respect to motor-driven table 18 beneath. As will be seen below, curved fitting 17 is caused to pass through devices 2, 4, 5 in sequence, causing motor-driven table 18 to move in the direction of arrow S in FIG. 2a and causing it to rotate in the direction of arrow R in FIG. 2b in order to follow the radius of curvature of the curved length until the situation in FIG. 2c is reached, where the said motor-driven table has travelled a particular length along tracks 19 and has rotated through 90° with respect to the position in FIG. 2a. In fact device 5, which is positioned close to the free end of curved fitting 17 in FIG. 2a is positioned at the end bearing mandrel 22 in FIG. 2c.

As an alternative to the systems for moving devices 2, 4 and 5 by corresponding drive means 9, 10 and 11 in FIG. 1 and to motor-driven table 18 moving the tubular body in FIGS. 2a, 2b, 2c, the tubular body which has to be coated can be supported on suitable saddles mounted on spherical feet which move freely on a suitable plane and follow all the movements of the tubular body with respect to the plane. The tubular body is caused to move forward mechanically through the various devices having a lenticular annular structure by means of a pair of suitable travelling rollers acting on the upper and lower generatrices of the tubular body. The spherical supporting feet disappear beneath the edge of the bench at the lenticular annular device and then pick up the tubular body again downstream thereof.

FIG. 3 illustrates sandblasting device 2 of lenticular annular structure in FIG. 1 positioned through a corresponding supporting frame, which is not shown, on motor-driven table 18 in FIGS. 2a, 2b, 2c running on two rails 19 and rotating with respect to pin 20. Mandrel 22, which comprises a blade 23 which is attached to plates 21 through an operation carried out offline and upstream from the various coating stages which have to be performed on said curved fitting 17 is attached to one extremity of curved fitting 17. This sandblasting device 2 is located at the free end of curved fitting 17, in the same way as device 5 in FIG. 2a, and comprises two half shells 102 and 202 which can preferably be separated from each other for fitting the same in the case of work on a conduit in the field, and a central through hole 302 through which said curved fitting 17 passes. Each of these half shells 102 and 202 comprises three sandblasting turbines 24 which project metal shot in a radial direction towards curved fitting 17 requiring coating. The six turbines 24 located in two half shells 102 and 202 are substantially located on a circumference corresponding to the periphery of sandblasting device 2 and are positioned at the same distance from each other and at the same distance from the outer surface of the curved fitting. The metal shot is fed to each of the two half shells 102 and 202 and then to the six turbines 24 through two corresponding conduits 26 connected to a bin 25 holding the shot. The number of turbines 24 in two half shells 102 and 202 may vary according to the diameter of the tubular body or length of conduit which has to be coated, in order to ensure complete cleaning of the entire surface of the tubular body.

FIG. 4 illustrates device 4 of lenticular annular structure in FIG. 1 for heating and simultaneously applying the epoxy primer and adhesive copolymer. This device 4 is preferably openable and is positioned on motor-driven table 18 so that it can move and rotate with respect to layers 19. In addition to this, said device 4 is located at the free end of curved fitting 17′ of the conduit which has undergone sandblasting treatment by means of the sandblasting device in FIG. 3, by means of a central through hole 304 with which the device is provided. This fitting 17′ will be supported by mandrel 22 and plates 21 in a manner which is wholly similar to that described above. This device 4 comprises a coil 104 for induction heating of curved fitting 17′ which precedes a series of nozzles 204 for the application of epoxy primer and adhesive copolymer to the surface of said curved fitting 17′. These nozzles 204 are substantially located on a circumference and are directed radially towards said curved fitting 17′, from which they are equally spaced. Also these nozzles 204 are equally spaced from each other along the circumference on which they are located.

FIG. 5 illustrates final coating device 5 of lenticular annular structure in FIG. 1. This device 5 is preferably openable and is located on motor-driven table 18 in a similar way to devices 2 and 4 in the preceding figures at the free end of curved fitting 17″ of the conduit, by means of a central through hole 105 with which the device is provided. This curved fitting 17″ has undergone sandblasting treatment through device 2 and heating and the application of epoxy primer and adhesive copolymer treatment through device 4. This device 5 comprises a lenticular cross-head 205 for the extrusion of a sleeve 27 of coating material such as polyethylene/polypropylene resin (PE/PPP), or syntactic PE/PP or PE/PP foam. As an alternative these materials may be compact thermohardening resins, for example polyurethane, epoxy, polyester, silicone or other resins, expanded thermohardening resins or syntactic thermohardening resins. This coating material is fed to lenticular head 205 of device 5 via a suitable conduit 28 connected to holes 29 provided in the annular border 305 of the body of said device 5 in a radial direction with respect to curved fitting 17″.

FIG. 6 illustrates a first embodiment of lenticular cross-head 205 in device 5. This lenticular head 205 comprises a posterior part 30 in which radial hole 29 is provided for feeding coating material circular anterior extrusion lip 31 attached to the said posterior part by suitable means 52. This first anterior circular extrusion lip 31 is connected to a second circular extrusion lip 32 positioned beneath the posterior part 30 of the head and is crossed by a channel 33 communicating with radial hole 29 and comprises anteriorly a substantially longitudinal section with respect to curved fitting 17″ of the pipe requiring coating. The coating material exits from this channel 33 between the extremities of the two circular lips 31 and 32 in such a way as to form the sleeve 27 of coating material on the surface of curved fitting 17″ of the conduit requiring coating. Radial hole 29 also communicates with channels 48 delivering coating material provided circumferentially in second circular lip 32 in the case where for example this coating material is polyolefin powder material.

FIG. 7 illustrates a second embodiment of lenticular cross-head 205′ in which the latter comprises a first anterior circular extrusion lip 34 and a second posterior circular extrusion lip 35 between which there is a channel 36 forming sleeve 27 of coating material around the outer surface of curved fitting 17″ requiring coating. This channel 36 comprises a first substantially vertical part which passes through a multiply perforated distribution ring 37 located between said circular lips 34 and 35 and a second part which is substantially longitudinal with respect to fitting 17″ requiring coating which faces the anterior part of cross-head 205′. Regardless of the type of cross-head however, device 5 is fixed and curved fitting 17″ moves through central through hole 105 in said device 5 as a result of translational and rotational movement of motor-driven table 18.

FIG. 8 illustrates a first embodiment of final coating device 5′ for curved fitting 17″ located on motor-driven table 18 which can run on two rails 19 and rotate with respect thereto. This device comprises a preferably openable lenticular body 105′ provided with a central through hole 305′ in which the free end of curved fitting 17″ is positioned. A rotating head 38 for the extrusion of a strip 39 of polyolefin coating material wound as a strip about that curved length is positioned on the inner annular edge 205′ of that lenticular body 105′. This coating material may be for example compact, expanded or syntactic polyethylene/polypropylene. The material is fed through radial hole 29 provided in the outer annular edge 405′ of lenticular body 105′, which is connected to corresponding coating material feed conduit 28. This rotating extrusion head 38 is illustrated in cross-section in FIG. 10 and comprises a final opening 40 of increasing cross-section delivering strip 39 of coating material. This final opening 40 communicates with radial coating material feed hole 29 located in the lenticular body of device 5′. The said rotating head 38 is connected through suitable attachment means 41 to a first rotating ring 42 which rotates through suitable movement means 43 such as bearings with respect to a second fixed ring 44 attached to lenticular body 105′ through suitable means 45. Provision is made for suitable annular seals 46 between this rotating head 38 and lenticular body 105′. In this example in FIG. 8 rotating head 38 can coat curved fitting 17″ with a flat strip 39, but, as an alternative, through suitable variation in the shape of final opening 40 in FIG. 10, the coating material may be extruded from that head in the form of a corrugated strip, a Z-shaped strip, a T-shaped strip, as a tubular strip, or in any form or cross-section in order to produce a strip which through its helical motion is spirally wound onto the tubular body in any shape and thickness. While tubular body/curved fitting 17″ advances through central through hole 305′ in lenticular body 105′ through the action of motor-driven table 18, rotating head 38 performs a substantially helical motion with respect to said curved tubular body 17″ and produces said strip 39. This first rotating ring 42 may also bear an appropriate pressing roller, preferably of silicone rubber, which performs a rotational/revolutionary motion about tubular body 17 requiring coating and exerts pressure on the outer surface of that tubular body 17″ at the point of first contact between strip 39 therewith in order to shape said strip 39 around tubular body 17″ even more effectively and prevent air from being trapped between said strip 39 and that tubular body 17″.

FIG. 9 illustrates a first embodiment of final coating device 5″ for curved fitting 17″ comprising a preferably openable lenticular ring 105″ having a central through hole 205″ in which the free end of curved fitting 17″ requiring coating is positioned. This lenticular ring 105″ which rotates within the tubular body comprises a reel 47 close to outer annular edge 305″ on which reel is wound a single or multilayer tape 50 of polyolefin material for coating the outer surface of curved tubular body 17″. This lenticular body 105″ rotates about said length 17″ which moves through said central through hole 205″ as a result of the translational and rotational motion of motor-driven table 18 on rails 19 through the action of suitable drive means 51.

With reference to the figures described, the method for the anticorrosion and thermally insulating coating of conduits for the transport of fluids according to this invention is as follows: the tubular body or conduit requiring coating, for example curved fitting 17, is mounted on metal plates 21 by means of supporting mandrel 22, the metal plates are then attached to motor-driven table 18 in such a way that they are in line with the axis of the straight length of tubular body bearing mandrel 22. At this point motor-driven table 18 is caused to move forward on rails 19 and if necessary rotate about rotation pin 20 so that the free end of curved fitting 17 is introduced into central through hole 302 of sandblasting device 2. At this point turbines 24 of said device 2 are brought into operation in order to deliver metal shot to curved fitting 17″. Once this first stage of coating treatment has been completed tubular body 17″ is subjected to heating and the application of epoxy primer and adhesive copolymer by means of device 4 in the manner described with reference to FIG. 4. Subsequently, when curved tubular body 17′ has been sandblasted and heated and the primer and copolymer have been applied to it, it passes to the final coating stage by means of device 5, 5′, 5″ described in its various embodiments in FIGS. 5-10. Substantially therefore, in the case of lengths of conduit such as in FIG. 1, devices 2, 4 and 5 may be moved in sequence along the pipe by means of the corresponding drive means, while in the case of curved or straight fittings the tubular body attached to motor-driven table 18 is caused to move through devices 2-4-5 in the various embodiments described in FIGS. 3-10 until treatment is complete.

Three examples of implementation of this method will be described below.

### EXAMPLE 1

Anticorrosion coating of the PP type in three layers having a thickness of 4 mm on a tubular body having the following characteristics: diameter 10″, 90° elbow, radius of curvature equal to four times the pipe diameter, length of the straight lengths welded to the ends of the curved part equal to one linear metre each.

The following materials were used: metal shot, powder epoxy primer, powder PP adhesive copolymer, granulated PP polymer.

Procedure: steel plates 21 bearing the tubular body by means of appropriate mandrel 22 and appropriately prepared off-line were placed on motor-driven table 18 and the tubular body was sandblasted to grade SA 2.5 using metal shot operating as indicated with reference to FIG. 2 using sandblasting device 2 instead of device 4. After sandblasting of the tubular body was complete, the latter was delivered by lateral movement of motor-driven table 18 to device 4 to heat it to 220° C. and apply 100-150 microns of primer and 80-120 microns of adhesive copolymer. After the stage of heating and application of the primer and adhesive the tubular body was delivered by means of motor-driven table 18 to device 5′ bearing rotating head 38 and an extruded strip of PP (polypropylene) was then wound around that tubular body.

### EXAMPLE 2

Anticorrosion coating with three layers of PP of thickness 4 mm on a pipe connecting joint coated with PP having the following characteristics: diameter 10″, thickness of the PP coating 4 mm, length of the joints requiring coating 300 mm. The following materials were used: metal shot, powder epoxy primer, powder PP adhesive copolymer, granulated PP polymer.

Procedure: The exposed metal part of the joint was sandblasted to grade SA 2.5 using metal shot by moving sandblasting device 2 along the joint. The metal pipe in the connecting joint area was heated to 220° C. by means of induction heating device 4 and 100-150 microns of epoxy primer and 80-120 microns of powder adhesive copolymer were applied to the joint in quick succession. The joint was transferred to device 5″ bearing rotating extrusion head 38 and the pressure roller and the joint was coated by winding an extruded strip 39 of PP thereon suitably overlapping the parent coating on the connected pipes.

### EXAMPLE 3

Anticorrosion and thermally insulating coating (“wet insulation”) for a pipe connection joint coated with 80 mm of syntactic PP, having the following characteristics: diameter 10″, thickness of the compact PP coating 80 mm, length of the joint requiring coating 300 mm.

The following materials were used: metal shot, powder epoxy primer, powder PP adhesive copolymer, granulated PP polymer.

Procedure: the metal part of the joint was sandblasted to grade SA 2.5 using metal shot and then heated and coated with primer and PP adhesive as in example 2. Device 5″ bearing rotating extrusion head 38 was transferred to the joint and the joint was coated by winding extruded strip 39 of PP thereon in several layers up to the desired thickness of 80 mm, suitably overlapping the parent coating of the connected pipes, reduced to the thickness of 4 mm.

1. Method for the anticorrosion and thermally insulating coating of tubular bodies, fittings, joints and conduits for the transport of fluids, characterised by the following stages in sequence:
a) positioning on a tubular body (1, 17, 17′, 17″) requiring coating a series of devices (2, 4, 5, 5′, 5″) for automatic coating of the said tubular body (1, 17, 17′, 17″) provided with suitable means (6, 7, 8, 9, 10, 11) for movement along the said tubular body (1, 17, 17′, 17″) and/or moving supporting equipment (18, 21) capable of permitting the said tubular body (1, 17, 17′, 17″) to move and rotate in the said automated coating devices (2, 4, 5, 5′, 5″),
b) sandblasting the surface of the said tubular body (1, 17, 17′, 17″) using suitable granular metal material,
c) heating the surface of the said tubular body (1, 17, 17′, 17″),
d) applying an epoxy resin and an adhesive resin to the said tubular body (1, 17, 17′, 17″),
e) final coating of the tubular body (1, 17, 17′, 17″) with thermoplastic, thermohardening or other coating materials.

2. Method of coating according to claim 1, characterised in that in the said stage e) the said coating is brought to completion through extruding a sleeve (27) of polyolefin material onto the tubular body (1, 17, 17′, 17″).

3. Method of coating according to claim 1, characterised in that in the said stage e) the said coating is brought to completion through extruding and winding a strip (39) of polyolefin material onto the tubular body (1, 17, 17′, 17″).

4. Method of coating according to claim 1, characterised in that in the said stage e) the said coating is brought to completion through the application of powder polyolefin material to the said tubular body (1, 17, 17′, 17″).

5. Method of coating according to claim 1, characterised in that in the said stage e) the said coating is brought to completion through winding a single or multilayer strip (50) of polyolefin material onto the tubular body (1, 17, 17′, 17″).

6. Method of coating according to claims 1-5, characterised in that the said final coating material according to stage e) comprises polyethylene-polypropylene resins, polyethylene-propylene foam, syntactic polyethylene-polypropylene, compact thermohardening resins such as polyurethane, epoxy, polyester, silicone or other resins, expanded thermohardening resins, syntactic thermohardening resins or the like.

7. Method of coating according to claim 3, characterised in that the said strip (39) wound onto the tubular body (1, 17, 17′, 17″) is of any shape such as a flat shape, a corrugated shape, a Z-shape, a T-shape, tubular or other shape.

8. Apparatus for implementing the method according to any one of the preceding claims, characterised in that it comprises: a first device (2) for sandblasting the tubular body (1, 17, 17′, 17″) requiring treatment provided with a plurality of turbines (24) for the delivery of granular sandblasting material, a second device (4) provided with first means (104) for induction heating and second means (204) for delivery of the epoxy primer and adhesive copolymer to the said tubular body (1, 17, 17′, 17″), and a third final coating device (5, 5′, 5″) provided with suitable means (205, 48, 47) for the delivery and/or extrusion of polyolefin material which is to be applied to the tubular body (1, 17, 17′, 17″), the said first, second and third devices (2, 4, 5, 5′, 5″) being connected to the said means (6-11) enabling them to move in sequence along the tubular body (1, 17, 17′, 17″) requiring treatment and/or the said tubular body (1, 17, 17′, 17″) being provided with the said moving supporting equipment (18, 21) through which the said tubular body (1, 17, 17′, 17″) can move forward and if necessary rotate in the said first, second and third treatment devices (2, 4, 5, 5′, 5″).

9. Equipment according to claim 8, characterised in that the said first, second and third treatment devices (2, 4, 5, 5′, 5″) comprise lenticular annular bodies which are preferably openable so that they can be positioned on the tubular body requiring treatment in the case of treatment in the field or on a lay barge.

10. Equipment according to claim 9, characterised in that the dimensions of the said lenticular annular structure forming the said first, second and third devices varies according to the longitudinal axis of the tubular body (1, 17, 17′, 17″) requiring coating between approximately 50 and approximately 400 mm and preferably between 100-200 mm.

11. Equipment according to claim 8, characterised in that it comprises at least one drive means (9, 10, 11) for each of the said first, second and third devices (2, 4, 5) containing material which is to be applied to the tubular body according to the stage of treatment which has to be performed on the said tubular body (1, 17, 17′, 17″), each of the said first, second and third devices (2, 4, 5) being connected to the corresponding drive means (9, 10, 11) through a corresponding conduit (13, 14, 15, 16) feeding the corresponding material which has to be applied on each of the said first, second and third devices (2, 4, 5) being provided with a corresponding structure (6, 7, 8) for drawing it along the tubular body (1, 17, 17′, 17″) requiring treatment.

12. Equipment according to claim 8, characterised in that the said mobile equipment comprises a motor-driven table (18) which is able to run along rails (19) and rotate with respect to a corresponding rotation pin (20) positioned substantially in the centre thereof, plates (21) supporting one end of the tubular body (17) requiring coating being fixed onto the said motor-driven table (18) and the other end of the said tubular body (17) being inserted by means of the said motor-driven table (18) into one of the said first, second and third devices (2, 4, 5) depending upon the stage of treatment which has to be performed on the said tubular body (17).

13. Equipment according to claim 11, characterised in that the said pair of plates (21) is fitted onto the motor-driven table (18) in such a way that their distance from the rotation pin (20) is approximately equal to the radius of curvature of the curved tubular body (17) requiring treatment.

14. Equipment according to claim 8, characterised in that the said tubular body (17) requiring coating is supported by suitable saddles mounted on spherical feet which move freely on a suitable plane and follow all the movements of the tubular body with respect to the plane, the tubular body being move by the various devices having a lenticular annular structure by means of a pair of appropriate translational rollers acting on the upper and lower generatrices of the said tubular body and the spherical supporting spheres disappearing beneath the edge of the plane where the lenticular annular equipment is located in order to then pick up the tubular body downstream thereof.

15. Equipment according to claim 8, characterised in that the said sandblasting device (2) comprises a pair of half shells (102, 202) which are joined together and can be separated from each other and are provided centrally with a through hole (302), with the said turbines (24) for the delivery of granular sandblasting material being positioned close to the periphery of the said half shells (102, 202) and the said turbines (24) being arranged radially with respect to the tubular body (17) requiring treatment and are equidistant from each other and with respect to the said tubular body (17).

16. Equipment according to claim 8, characterised in that the said sandblasting device (2) comprises a bin (25) containing granular sandblasting material, conduits (26) feeding the said turbines (24) with the said granular sandblasting material leading from the said bin (25).

17. Equipment according to claim 15, characterised in that the said sandblasting device (2) comprises the same number of turbines (24), preferably three, on each of the two half shells (102, 202).

18. Equipment according to claim 8, characterised in that the said second device (4) comprises a coil (104) for induction heating of the tubular body (17′) requiring treatment which precedes a series of nozzles (204) applying the epoxy primer and the adhesive copolymer to the surface of the said tubular body (17′), the said nozzles (204) being substantially located on a circumference of the body of lenticular structure of the device (4), equally spaced from each other and radially directed towards the said tubular body (17′).

19. Equipment according to claim 8, characterised in that the said third final coating device (5, 5′) comprises a lenticular cross-head (205, 205′) for extrusion of the said sleeve (27) of coating material having a central through hole (105), with a radial hole (29) to feed the coating material via a corresponding external conduit (28) being provided on the outer annular edge (305) of the said lenticular head (205, 205′).

20. Equipment according to claim 8, characterised in that the said lenticular head (205) comprises a posterior part (30) in which the said radial hole (29) for feeding coating material is provided and a first anterior circular extrusion lip (31) fixed to the said posterior part by suitable means (52), the said first anterior circular extrusion lip (31) being connected to a second circular extrusion lip (32) located beneath the posterior part (30) of the head and being traversed by a channel (33) communicating with the said radial hole (29).

21. Equipment according to claim 19, characterised in that the said radial hole (29) in the said posterior part of the lenticular head (205) communicates with channels (48) for the delivery of coating material provided circumferentially in the said second circular lip (32).

22. Equipment according to claim 19 characterised in that the said lenticular extrusion head (205′) comprises a first anterior circular extrusion lip (34) and a second posterior circular extrusion lip (35) between which there is provided a channel (36) for forming the said sleeve (27) of coating material, the said channel (36) being provided with a first substantially vertical part which passes through a multiperforated distribution ring (37) located between the said circular lips (34, 35) and a second part which is substantially longitudinal with respect to the tubular body (17″) requiring coating and facing the anterior part of the said lenticular extrusion hub (205′).

23. Equipment according to claim 8, characterised in that the said third device (5′) comprises a lenticular body (105′) provided with a central through hole (305′) on the annular edge (205′) of which there is positioned a rotating extrusion head (38) capable of forming the said strip (39) of coating material extruded onto the tubular body (17″) requiring treatment.

24. Equipment according to claim 23, characterised in that the said rotating extrusion head (38) comprises a final opening (40) of increasing cross-section for delivery of the strip (39) of coating material and is in communication with the radial hole (29) delivering coating material provided in the lenticular body (105′), the said rotating head (38) being attached by a suitable attachment means (41) to a first rotating ring (42) which is capable of moving with respect to a second fixed ring (44) which is fixed to the lenticular body (105′) by suitable means (45) and with suitable annular seals (46) being provided between the said rotating head (38) and the said lenticular body (105′).

25. Equipment according to claim 24, characterised in that the said first rotating ring (42) bears a pressure roller, preferably of silicone rubber, which performs a rotational-revolutionary movement about the tubular body requiring coating.

26. Equipment according to claim 8, characterised in that the said third device (5″) comprises a lenticular body (105″) having a central through hole (205″) and a reel (47) close to its outer annular edge (305″) around which reel there is wound a single layer or multilayer tape (50) of polyolefin material for coating the outer surface of the said tubular body (17″), the said lenticular body (105″) being capable of rotating about the said tubular body through suitable drive means (51).
